(19) United States
(12) Patent Application Publication
(10) Pub. No.: US 2013/0330118 A1
(43) Pub. Date: Dec. 12, 2013

(54) Cable-Actuated Latching Mechanism

(71) Applicant: Trace Eugene Van Dyne, Sunbury, OH (US)

(72) Inventor: Trace Eugene Van Dyne, Sunbury, OH (US)

(21) Appl. No.: 13/914,509

(22) Filed: Jun. 10, 2013

Related U.S. Application Data
(60) Provisional application No. 61/658,345, filed on Jun. 11, 2012.

(51) Int. Cl. F16B 7/10

(52) U.S. Cl. CPC F16B 7/10
USPC 403/109.2

(57) ABSTRACT

A cable-actuated latching mechanism is disclosed herein. In one or more embodiments, the cable-actuated latching mechanism includes an insert body having at least one groove formed therein; a bent elongated strip disposed in the at least one groove of the insert body; a detent coupled to the bent elongated strip; and an actuation cable or wire operatively coupled to the bent elongated strip, a portion of the actuation cable or wire being disposed in the insert body. When an axial force is applied to the actuation cable or wire of the latching mechanism, the bent elongated strip is elastically deformed and displaced inwardly, thereby displacing the detent in a similar inward manner. In one or more embodiments, the cable-actuated latching mechanism is configured to selectively prevent the relative sliding movement of an inner tubular member relative to an outer tubular member.

### CROSS-REFERENCE TO RELATED APPLICATIONS

This patent application claims priority to, and incorporates by reference in its entirety, pending U.S. Provisional Patent Application No. 61/658,345, entitled “Cable-Actuated Latching Mechanism”, filed on Jun. 11, 2012.

### STATEMENT REGARDING FEDERALLY SPONSORED RESEARCH OR DEVELOPMENT

Not Applicable.

### NAMES OF THE PARTIES TO A JOINT RESEARCH AGREEMENT

Not Applicable.

### INCORPORATION BY REFERENCE OF MATERIAL SUBMITTED ON A COMPACT DISK

Not Applicable.

### BACKGROUND OF THE INVENTION

1. Field of the Invention

The invention generally relates to latching mechanisms. More particularly, the invention relates to a cable-actuated latching mechanism, wherein a detent is disengaged by virtue of a tensile force being applied to a cable operatively coupled thereto.

2. Background and Description of Related Art

Conventional latching devices having a manually releasable snap button are known in the art. In these devices, a user must typically apply a force to the outer, top surface of the snap button in order to release the latching device. Because a product utilizing latching devices often contains a plurality of latching devices that must be simultaneously released in order to achieve the desired result (e.g., the collapsing of a particular structure), it is quite cumbersome for the user of the product to manually release each latching device to achieve the desired functionality. Moreover, these latching devices are commonly located in disparate locations on the product, further adding to the burden imposed on the user of the product. Furthermore, because each latching device is completely independent from the other latching devices in the assembly, there is no plausible way to simultaneously release all of the latching devices in the assembly.

Therefore, what is needed is a latching mechanism that can be quickly and easily actuated from a remote location, thereby obviating the need to apply a manual force to an outer surface of the latching device itself. Also, a latching mechanism is needed that can be easily manufactured from readily available materials. In addition, a latching mechanism is needed that can be easily combined with other latching mechanisms in an assembly such that each of the latching mechanisms in the assembly can be actuated in a simultaneous, or substantially simultaneous, manner when a user actuates a single release mechanism.

### BRIEF SUMMARY OF EMBODIMENTS OF THE INVENTION

Accordingly, the present invention is directed to a cable-actuated latching mechanism that substantially obviates one or more problems in the related art hereinbefore discussed.

In accordance with one aspect of one or more embodiments of the present invention, there is provided a cable-actuated latching mechanism that includes: an insert body having at least one groove formed therein; a bent elongated strip, a portion of the bent elongated strip disposed in the at least one groove of the insert body; a detent coupled to the bent elongated strip; and an actuation cable or wire operatively coupled to the bent elongated strip, a portion of the actuation cable or wire being disposed in the insert body. In this embodiment, when an axial force is applied to the actuation cable or wire, the bent elongated strip is elastically deformed and displaced inwardly, thereby displacing the detent in a similar inward manner.

In a further embodiment of this aspect of the present invention, the insert body comprises a flanged end.

In yet a further embodiment, the insert body comprises an aperture disposed transversely therethrough, one portion of the bent elongated strip configured to be received within the aperture.

In still a further embodiment, the at least one groove of the insert body comprises a first groove formed in a first surface of the insert body and a second groove formed in a second surface of the insert body, another portion of the bent elongated strip configured to be received within the first groove of the insert body, and a portion of the actuation cable or wire configured to be received within the second groove of the insert body.

In yet a further embodiment, the insert body further comprises a dividing partition separating the first groove from the second groove.

In still a further embodiment, the first groove and the second groove of the insert body connect to the aperture that is disposed transversely through the insert body.

In yet a further embodiment, the insert body has one of: (i) a substantially square cross-sectional shape, and (ii) a circular cross-sectional shape.

In accordance with another aspect of one or more embodiments of the present invention, there is provided a cable-actuated latching mechanism that includes: a bent elongated strip; a detent coupled to the bent elongated strip; and an actuation cable or wire operatively coupled to the bent elongated strip. In this embodiment, when an axial force is applied to the actuation cable or wire, the bent elongated strip is elastically deformed and displaced inwardly, thereby displacing the detent in a similar inward manner.

In a further embodiment of this aspect of the present invention, the bent elongated strip comprises a first strip portion and a second strip portion, the second strip portion being bent at an acute angle relative to the first strip portion and having an aperture disposed therethrough for receiving the actuation cable or wire, the detent being attached to the first strip portion.

In yet a further embodiment, the bent elongated strip further comprises a third strip portion and a fourth strip portion, the fourth strip portion being disposed at an acute angle relative to the first strip portion, the third strip portion comprising a filleted corner connecting the first strip portion to the fourth strip portion.

In still a further embodiment, the fourth strip portion of the bent elongated strip comprises a bent end, and wherein the bent end of the fourth strip portion is configured to act as a guide for the actuation cable or wire, the actuation cable or wire being configured to bend around the bent end of the fourth strip portion.

In yet a further embodiment, the actuation cable or wire is provided with a flattened head portion so that the actuation cable or wire does not slip out of the aperture in the second strip portion.

In still a further embodiment, the detent has an eccentric conical shape so as to facilitate an insertion of the latching mechanism into an end of a tubular member.

In accordance with yet another aspect of one or more embodiments of the present invention, there is provided a cable-actuated latching mechanism configured to selectively prevent the relative sliding movement of an inner tubular member relative to an outer tubular member, which includes: an insert body having at least one groove formed therein, the insert body configured to be received within an interior of the inner tubular member; a bent elongated strip, a portion of the bent elongated strip disposed in the at least one groove of the insert body; a detent coupled to the bent elongated strip; and an actuation cable or wire operatively coupled to the bent elongated strip, a portion of the actuation cable or wire being disposed in the insert body. In this embodiment, when an axial force is applied to the actuation cable or wire, the bent elongated strip is elastically deformed and displaced inwardly, thereby displacing the detent in a similar inward manner and releasing the detent from an aperture in the outer tubular member so as to enable the relative sliding movement of the inner tubular member relative to the outer tubular member.

In a further embodiment of this aspect of the present invention, the insert body further comprises an aperture disposed transversely therethrough, one portion of the bent elongated strip configured to be received within the aperture.

In yet a further embodiment, the at least one groove of the insert body comprises a first groove formed in a first surface of the insert body and a second groove formed in a second surface of the insert body, another portion of the bent elongated strip configured to be received within the first groove of the insert body, and a portion of the actuation cable or wire configured to be received within the second groove of the insert body.

In still a further embodiment, the insert body further comprises a dividing partition separating the first groove from the second groove.

In yet a further embodiment, the bent elongated strip comprises a first strip portion and a second strip portion, the second strip portion being bent at an acute angle relative to the first strip portion and having an aperture disposed therethrough for receiving the actuation cable or wire, the detent being attached to the first strip portion.

In still a further embodiment, the bent elongated strip further comprises a third strip portion and a fourth strip portion, the fourth strip portion being disposed at an acute angle relative to the first strip portion and having a bent end, the third strip portion comprising a filleted corner connecting the first strip portion to the fourth strip portion.

In yet a further embodiment, a portion of the fourth strip portion of the bent elongated strip is received within the first groove of the insert body, and wherein the bent end of the fourth strip portion is received within the aperture that is disposed transversely through the insert body.

It is to be understood that the foregoing general description and the following detailed description of the present invention are merely exemplary and explanatory in nature. As such, the foregoing general description and the following detailed description of the invention should not be construed to limit the scope of the appended claims in any sense.

### BRIEF DESCRIPTION OF THE SEVERAL VIEWS OF THE DRAWINGS

The invention will now be described, by way of example, with reference to the accompanying drawings, in which:

FIG. 1 is a top perspective view of a latching mechanism according to a first embodiment of the invention;

FIG. 2 is a bottom perspective view of the latching mechanism according to the first embodiment of the invention;

FIG. 3 is a top perspective view of a latching mechanism according to a second embodiment of the invention;

FIG. 4 is a bottom perspective view of the latching mechanism according to the second embodiment of the invention;

FIG. 5 is a side sectional view of the latching mechanism according to the second embodiment of the invention, wherein the section is cut along the cutting-plane line A-A in FIGS. 3 and 4;

FIG. 6 is a side perspective view of a first type of snap button assembly of the latching mechanisms, according to an embodiment of the invention;

FIG. 7 is a frontal perspective view of a first type of snap button assembly of the latching mechanisms, according to the embodiment of the invention in FIG. 6;

FIG. 8 is a frontal perspective view of a second type of snap button assembly of the latching mechanisms, according to an embodiment of the invention;

FIG. 9 is a side perspective view of a second type of snap button assembly of the latching mechanisms, according to the embodiment of the invention in FIG. 8;

FIG. 10 is a top perspective view of an insert body (snap button carriage) of the latching mechanism according to the first embodiment of the invention;

FIG. 11 is a bottom perspective view of an insert body (snap button carriage) of the latching mechanism according to the first embodiment of the invention;

FIG. 12 is a first end perspective view of the insert body (snap button carriage) of the latching mechanism according to the first embodiment of the invention;

FIG. 13 is a second end perspective view of the insert body (snap button carriage) of the latching mechanism according to the first embodiment of the invention;

FIG. 14 is a top perspective view of the insert bodies (snap button carriages) and a side perspective view of the first type of snap button assembly of the first and second embodiments of the latching mechanism;

FIG. 15 is a bottom perspective view of the insert bodies (snap button carriages) of the first and second embodiments of the latching mechanism;

FIG. 16 is a top perspective view of the latching mechanism according to the second embodiment of the invention;

FIG. 17 is a side perspective view of the latching mechanism according to the second embodiment of the invention being inserted into the end of a tubular member;

FIG. 18 is a top perspective view of the latching mechanism according to the second embodiment of the invention being inserted into the end of a tubular member;

FIG. 19 is a bottom perspective view of the latching mechanism according to the second embodiment of the invention being inserted into the end of a tubular member;

FIG. 20 is a side perspective view of the latching mechanism according to the second embodiment of the invention after it has been fully inserted into the end of a tubular member;

FIG. 21 is a top perspective view of the latching mechanism according to the first embodiment of the invention being inserted into the end of a tubular member;

FIG. 22 is a bottom perspective view of the latching mechanism according to the first embodiment of the invention being inserted into the end of a tubular member;

FIG. 23 is a side perspective view of the latching mechanism according to the first embodiment of the invention after it has been fully inserted into the end of a tubular member;

FIG. 24 is a partial side perspective view of a first inner tubular member engaged with a first outer tubular member by virtue of the latching mechanism according to the first embodiment of the invention being in an engaged position, wherein a portion of the first outer tubular member is shown cutaway;

FIG. 25 is a partial side perspective view of the first inner tubular member disengaged from the first outer tubular member by virtue of the latching mechanism according to the first embodiment of the invention having been released, wherein a portion of the first outer tubular member is shown cutaway;

FIG. 26 is a partial side perspective view of a second inner tubular member engaged with a second outer tubular member by virtue of the latching mechanism according to the second embodiment of the invention being in an engaged position, wherein a portion of the second outer tubular member is shown cutaway; and

FIG. 27 is a partial side perspective view of the second inner tubular member disengaged from the second outer tubular member by virtue of the latching mechanism according to the second embodiment of the invention having been released, wherein a portion of the second outer tubular member is shown cutaway.

Throughout the figures, the same parts are always denoted using the same reference characters so that, as a general rule, they will only be described once.

### DETAILED DESCRIPTION OF EMBODIMENTS OF THE INVENTION

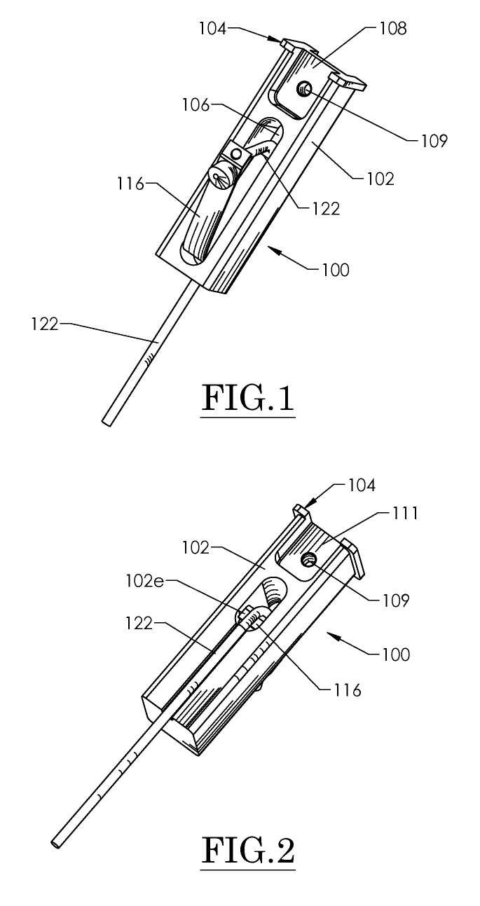

A first embodiment of the latching mechanism is seen generally at 100 in FIGS. 1 and 2. The latching mechanism 100 of the depicted embodiment principally comprises an insert body (or snap button carriage) 102 and a snap button assembly 116. A frontal perspective view of the latching mechanism 100 is illustrated in FIG. 1, whereas a rear perspective view of the latching mechanism 100 is illustrated in FIG. 2. In the first exemplary embodiment of the invention, the insert body 102 is generally in the form of a rectangular solid.

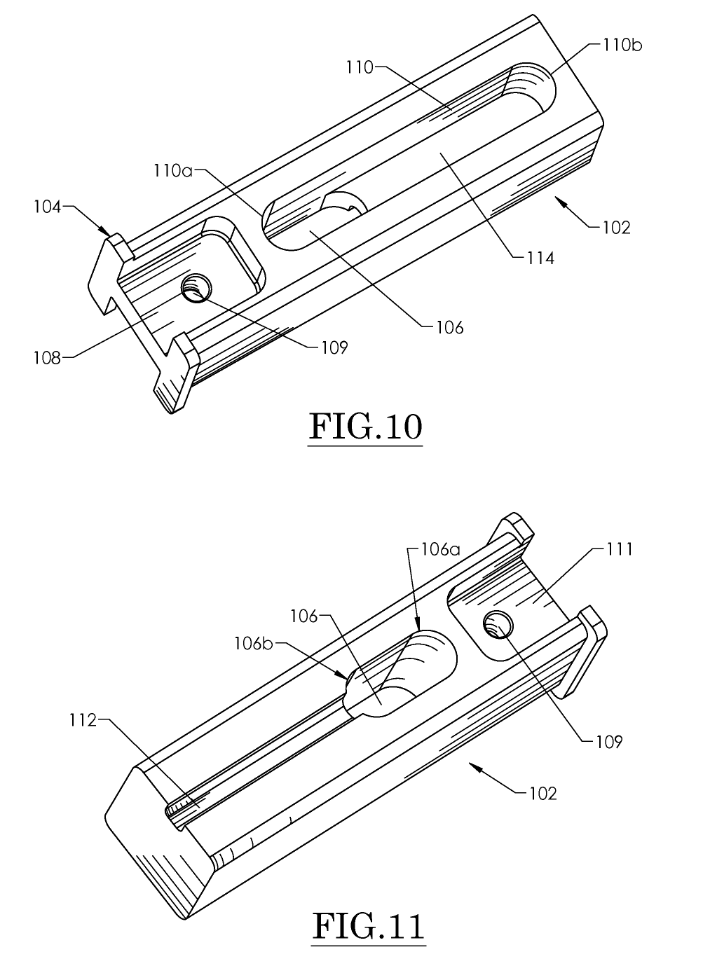

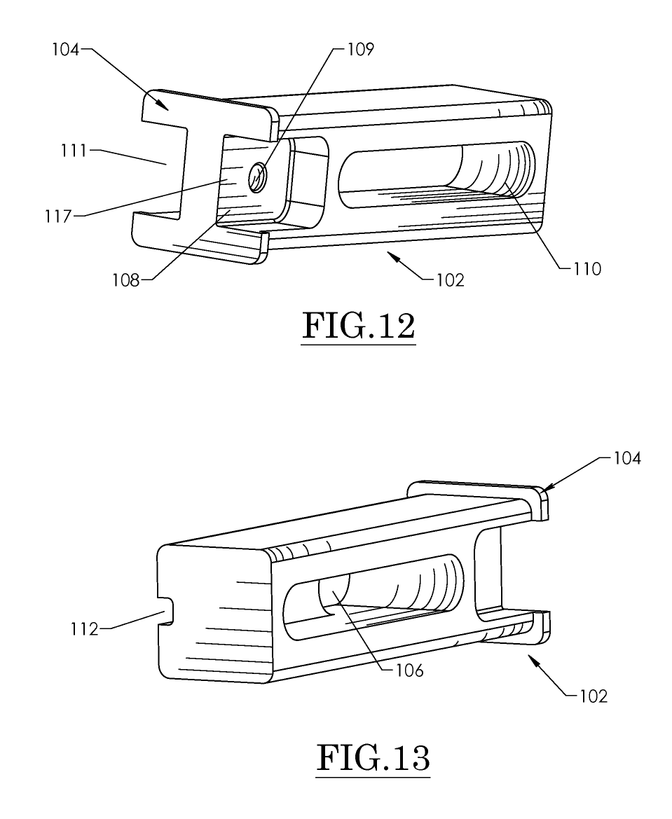

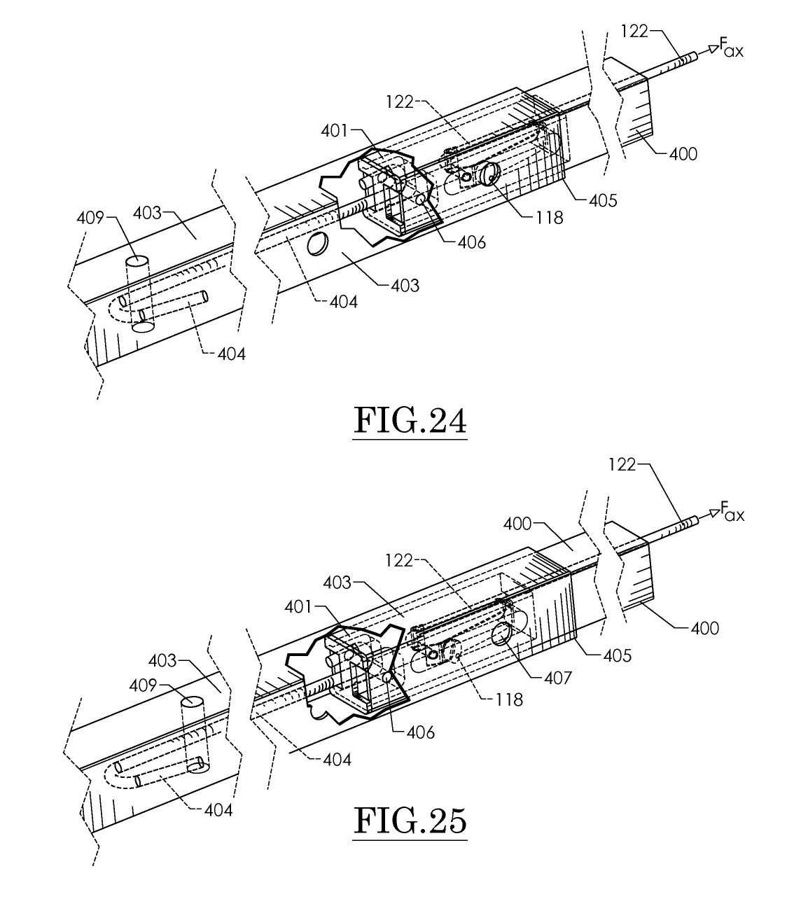

Referring to FIGS. 10-13, it can be seen that the insert body 102 has a flanged first longitudinal end 104. Also, as best seen in FIG. 12, the first end of the insert body 102 is preferably provided with notches 108, 111 disposed on opposed sides thereof (i.e., opposed top and bottom sides). In addition, as shown in FIGS. 10-12, a circular aperture 109 is provided in the dividing wall (or dividing partition) 117, which is disposed between, and separates, the notches 108, 111. When the latching mechanism 100 is used in conjunction with a telescoping leg assembly having an inner tubular member 400 and an outer tubular member 403 (see e.g., FIGS. 24 and 25), the notches 108, 111 may serve two purposes. First, the notches 108, 111 may allow for the passage of air on opposed sides of the latching mechanism 100 so as to facilitate the sliding of the inner tubular member 400 relative to the outer tubular member 403. Secondly, the notches 108, 111 may enable a stop rod 404 to be attached to the interior of the latching mechanism 100 (see FIGS. 24 and 25); the stop rod 404 prevents the inner tubular member 400 from becoming completely disengaged from the outer tubular member 403 (i.e., by preventing the end 401 of the inner tubular member 400 from sliding out of the end 405 of the outer tubular member 403). In particular, as shown in FIGS. 24 and 25, the hooked end of the stop rod 404 catches on the rod 409 in the outer tubular member 403, thereby preventing the inner tubular member 400 from sliding out of the end 405 of the outer tubular member 403. As shown in FIG. 24, a fastener 406 disposed through the circular aperture 109 is used to affix the end of the stop rod to the insert body 102.

Next, with reference to FIGS. 10 and 11, it can be seen that the insert body 102 is provided with another aperture 106 disposed transversely therethrough. As illustrated in these figures, the aperture 106 is preferably provided with rounded ends 106a, 106b. On the top side of the insert body 102, a first groove 110 with rounded ends 110a, 110b is provided for receiving the snap button therein (FIG. 10). Conversely, on the bottom side of the insert body 102, a second groove 112 is provided for receiving the actuation cable 122 (or wire 122) of the snap button assembly 116. As best shown in FIG. 10, the first groove 110 is separated from the second groove 112 by a dividing partition 114. Unlike the first longitudinal end of the insert body 102, the second longitudinal end thereof is not provided with a flange (see FIG. 13).

In one or more embodiments of the invention, the insert body 102 of the latching mechanism 100 is formed from a generally rigid polymeric material (i.e., a generally rigid plastic). However, one of ordinary skill in the art will readily appreciate that the invention is not so limited. Rather, other suitable generally rigid materials can be used for forming the insert body 102, such as suitable composites.

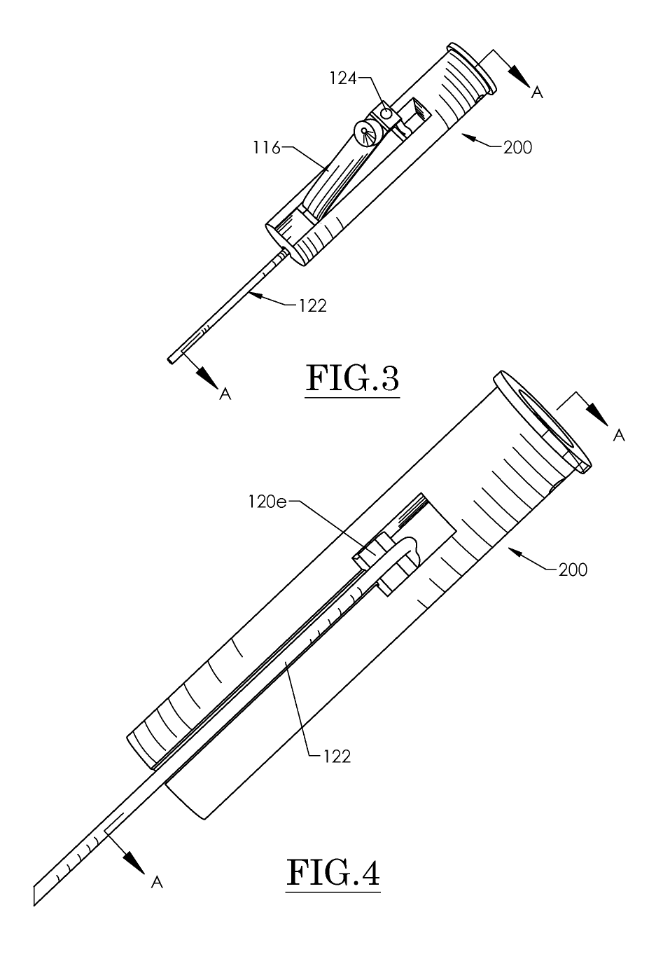

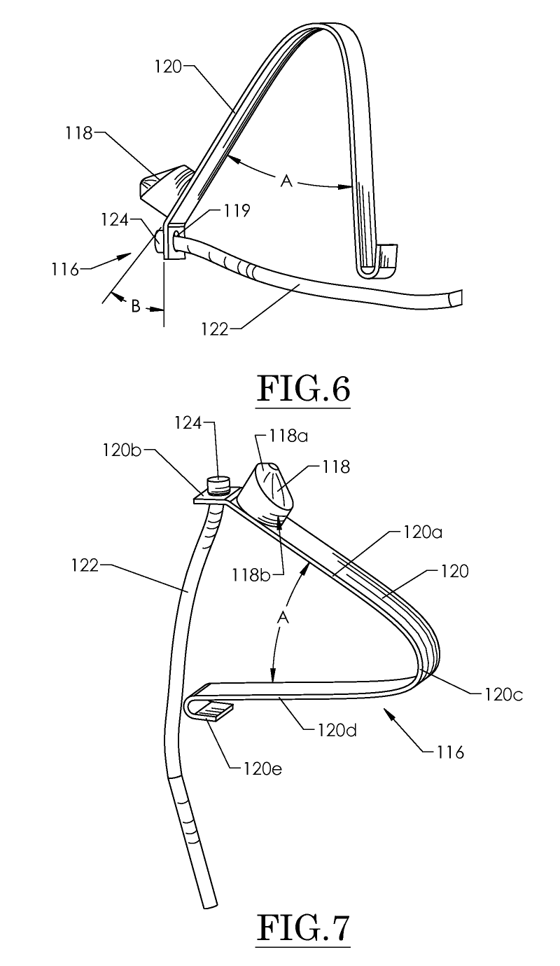

Now, turning to FIGS. 6 and 7, a first type of snap button assembly 116 that may form a portion of the latching mechanism 100 will be described. It can be seen that the snap button assembly 116 generally comprises an elongated strip 120 bent at an obtuse angle and an actuation cable 122 (or wire 122). With particular reference to FIG. 7, it can be seen that the elongated strip 120 includes a first strip portion 120a with a detent 118 attached thereto, a second strip portion 120b bent at an acute angle B with respect to the first strip portion 120a and having an aperture 119 disposed therein (see FIG. 6), a third filleted strip portion 120c, and a fourth strip portion 120d with a bent end 120e. The third filleted strip portion 120c connects the first strip portion 120a to the fourth strip portion 120d (the first strip portion 120a and the fourth strip portion 120d form an acute angle A therebetween). As depicted in FIGS. 6 and 7, the aperture 119 in second strip portion 120b receives an end portion of the actuation cable 122. In order to ensure that the end portion of the actuation cable 122 does not slip out of the aperture 119 in the second strip portion 120b, the end of the actuation cable 122 is provided with a flatten head portion 124 (e.g., see FIGS. 3, 5, and 7).

As best illustrated in FIG. 7, the detent 118 has a top portion 118a with an eccentric conical shape and a base portion 118b that is generally cylindrical. Advantageously, the eccentric conical shape of the top portion 118a of the detent 118 facilitates the insertion of the latching mechanism 100 into the end of a tubular member (e.g., tubular member 400 in FIG. 21) because the sloped side wall of the top portion 118a of the detent 118 does not catch on the end of the tubular member 400.

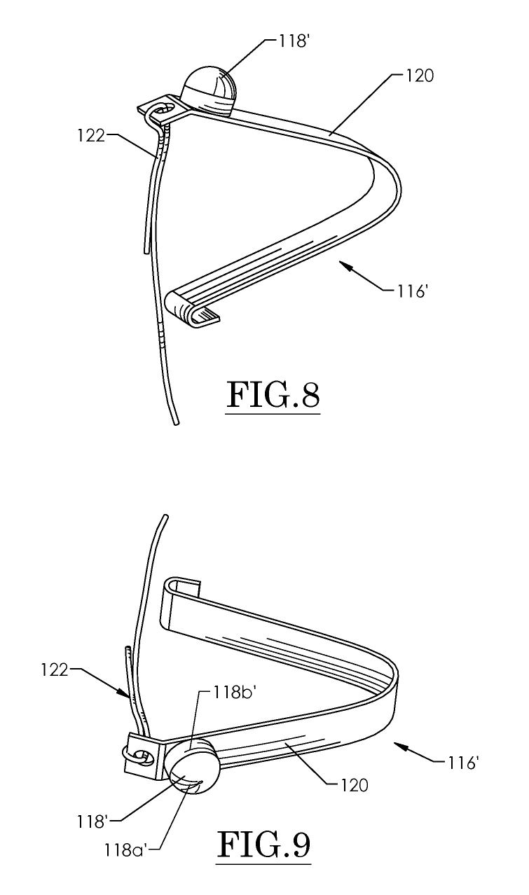

A second type of snap button assembly 116′ that may form a portion of the latching mechanism 100 is illustrated in FIGS. 8 and 9. The snap button assembly 116′ is similar in most respects to the snap button assembly 116 described above. However, the detent 118′ of the snap button assembly 116′ has a geometry that is different from the detent 118 of the snap button assembly 116. Unlike the detent 118 which has a top portion 118a with an eccentric conical shape (see FIGS. 6 and 7), the detent 118′ has a top portion 118a′ with a generally symmetrical dome shape (see FIGS. 8 and 9). Similar to the detent 118, the base portion 118b′ of the detent 118′ is generally cylindrical.

In one or more embodiments of the invention, the elongated strips 120 of the snap button assemblies 116, 116′ are formed from an elastically deformable material, such as a resilient metal. However, one of ordinary skill in the art will readily appreciate that the invention is not so limited. Rather, other suitable elastically deformable materials can be used for forming the elongated strips 120.

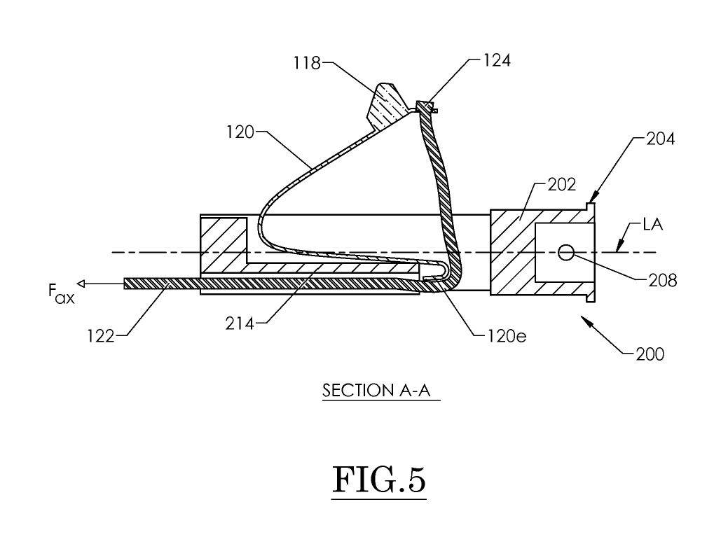

As best shown in FIGS. 1 and 2, the elongated strip 120 of the snap button assembly 116 is received within a portion of the aperture 106, and within the first groove 110 of the insert body 102. The rounded (filleted) ends 106a, 106b, 110a, 110b of both the aperture 106 and the first groove 110 maintain the elongated strip 120 in the appropriate position (i.e., the elongated strip 120 is constrained in the longitudinal direction by the rounded (converging) ends of the aperture 106 and the first groove 110). Referring to FIG. 2, it can be seen that the bent end 120e of the elongated strip 120 is disposed within a bottom portion of the aperture 106. The bent end 120e acts as a guide for the actuation cable 122 (i.e., the actuation cable 122 bends around the bent end 120e before it is routed through the second groove 112—see FIGS. 2 and 5).

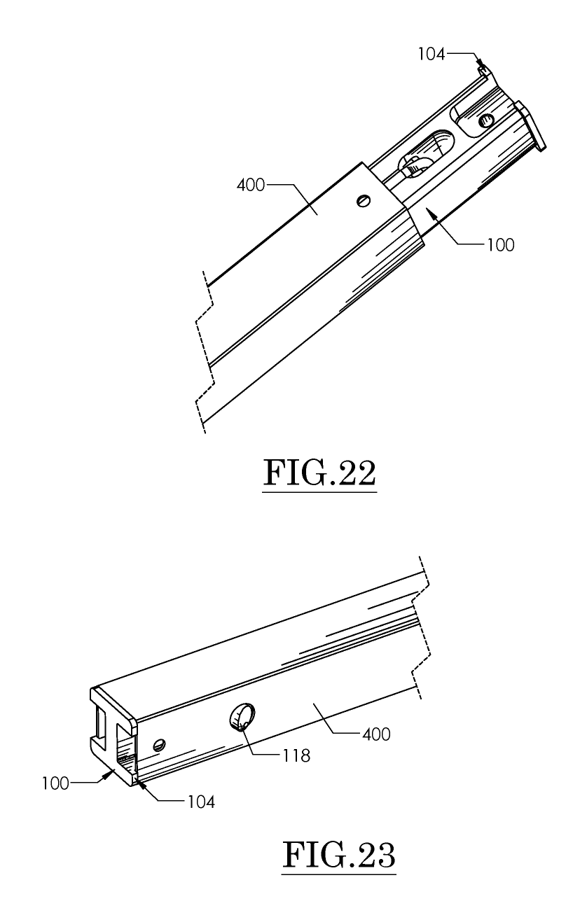

The manner in which the latching mechanism 100 is inserted into a tubular member is depicted in FIGS. 21-23. As illustrated in these figures, the insert body 102 of the latching mechanism 100 is inserted into the end of a tubular member 400 until the inner rim of its flanged first end 104 abuts the peripheral edge of the tubular member 400. When the insert body 102 of the latching mechanism 100 is fully inserted into the interior cavity of the tubular member 400, the detent 118 extends through the aperture 402 in the side wall of the tubular member 400 (see FIGS. 21 and 23).

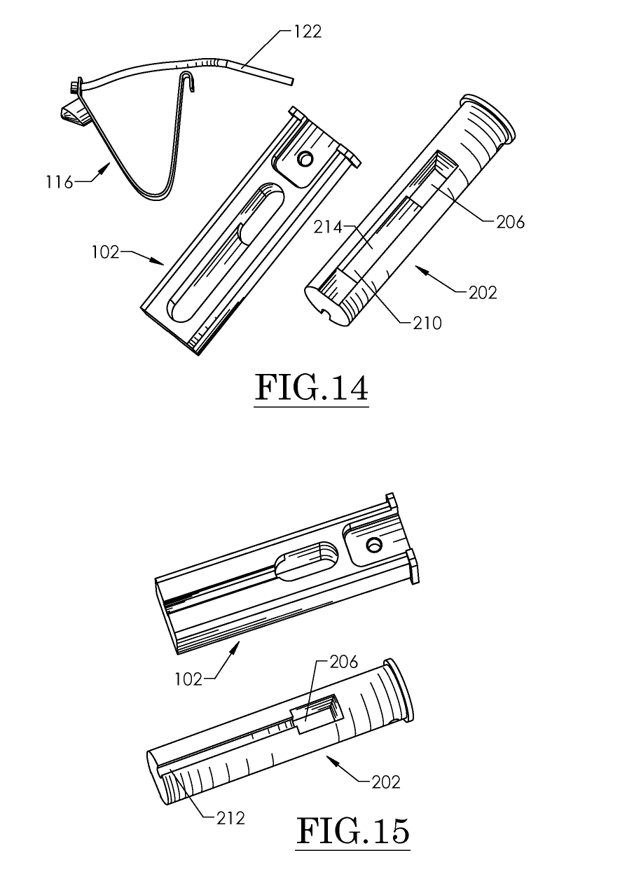

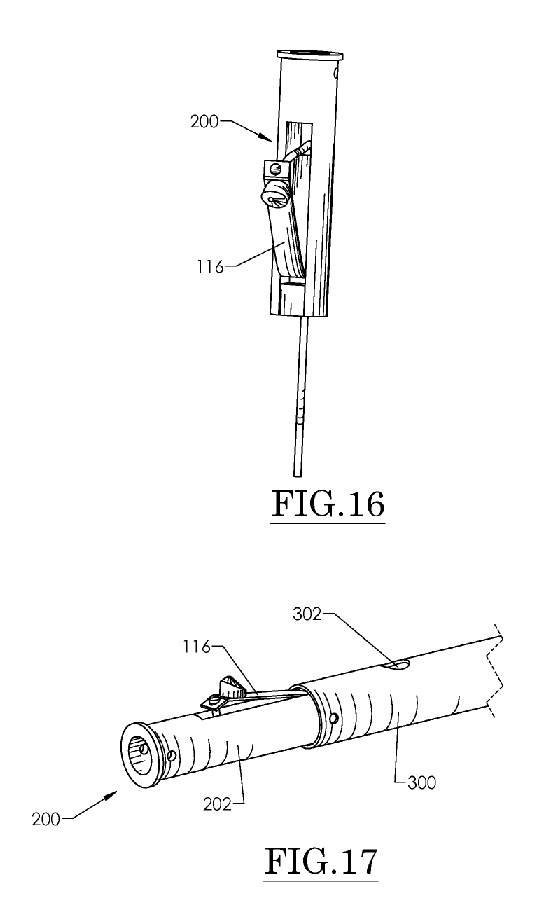

Now, a second embodiment of the latching mechanism will be described with reference to FIGS. 3 and 4. Like the first embodiment described above, the latching mechanism 200 of the second embodiment principally comprises an insert body (or snap button carriage) 202 and a snap button assembly 116. A frontal perspective view of the latching mechanism 200 is illustrated in FIG. 3, whereas a rear perspective view of the latching mechanism 200 is illustrated in FIG. 4. The latching mechanism 200 of the second embodiment is similar in most respects to the latching mechanism 100 of the first embodiment. For example, referring to the sectional view of FIG. 5, and the top and bottom perspective views of FIGS. 14 and 15, it can be seen that, like the insert body 102 of the first embodiment, the insert body 202 of the second embodiment includes a flanged first end 204, an aperture 206 disposed transversely therethrough, a first groove 210 on its top side, a second groove 212 on its bottom side, and a dividing partition 214 by which the first groove 210 is separated from the second groove 212.

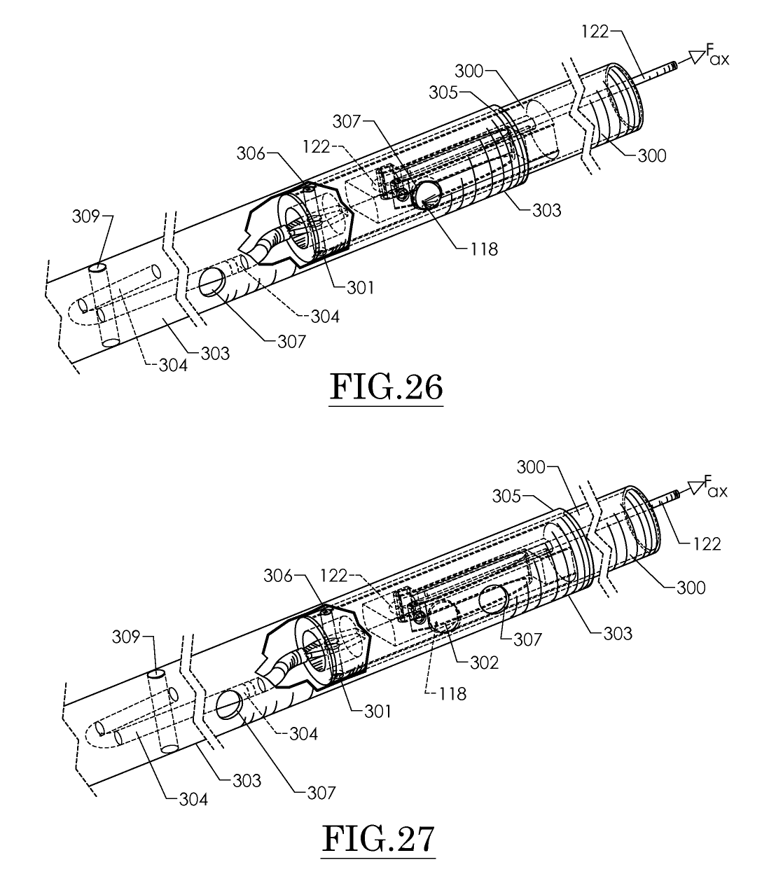

However, unlike the insert body 102, the insert body 202 has a generally cylindrical geometry, rather than that of a rectangular solid. The generally cylindrical geometry of the insert body 202 is designed to be inserted into a tubular member having a circular cross-section (e.g., tubular member 300), whereas the rectangular (substantially square) cross-sectional shape of the insert body 102 is designed to be inserted into a tubular member having a rectangular (substantially square) cross-section (e.g., tubular member 400). In addition, rather than having a first end that is provided with notches 108, 111 and a dividing partition 117 therebetween like the first embodiment, the insert body 202 of the second embodiment is provided with a substantially circular bore 208 disposed therein, the circular bore 208 extending generally axially within the insert body 202 (see e.g., FIGS. 5, 18, and 19). The circular bore 208 of the insert body 202 serves similar purposes to that of the notches 108, 111 and dividing partition 117 of the first embodiment. First, the substantially circular bore 208 allows for the passage of air into the latching mechanism 200 so as to facilitate the sliding of the inner tubular member relative to the outer tubular member. Secondly, the substantially circular bore 208 enables a stop rod 304 to be attached to the interior of the latching mechanism 200 by means of rod or fastener 306; the stop rod 304 prevents the inner tubular member 300 from becoming disengaged from the outer tubular member 303 (e.g., see FIGS. 26 and 27). In particular, as shown in FIGS. 26 and 27, the hooked end of the stop rod 304 catches on the rod 309 in the outer tubular member 303, thereby preventing the end 301 of the inner tubular member 300 from sliding out of the end 305 of the outer tubular member 303.

Another difference between the insert body 202 and the insert body 102 is best illustrated in FIGS. 14 and 15. As shown in these figures, unlike the aperture 106 and the first groove 110 of the insert body 102, the aperture 206 and the first groove 210 do not have rounded ends. Rather, as shown in FIGS. 14 and 15, the ends of the aperture 206 and the first groove 210 are substantial squared (i.e., the corners of the aperture 206 and the first groove 210 comprise substantially 90 degree angles). As such, the squared ends of both the aperture 206 and the first groove 210 maintain the elongated strip 120 in the appropriate position (i.e., the elongated strip 120 is constrained in the longitudinal direction by the squared ends of the aperture 206 and the first groove 210).

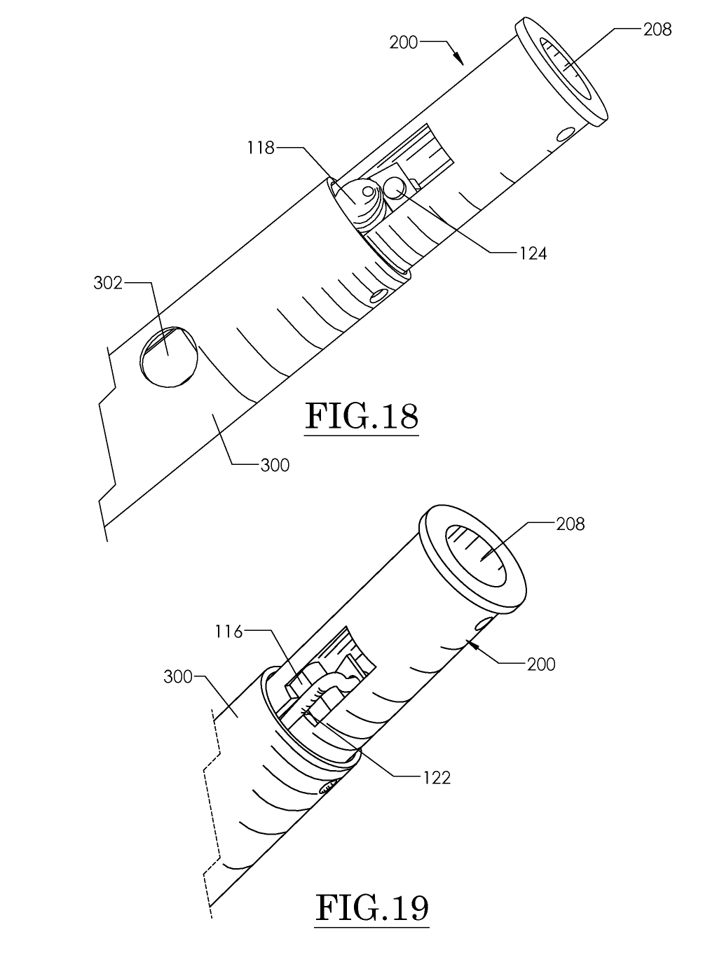

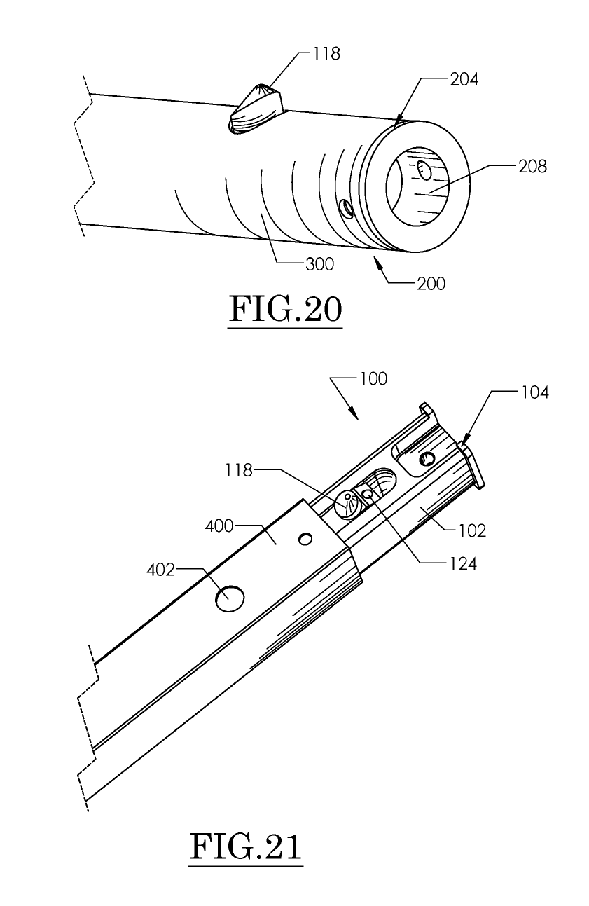

The manner in which the latching mechanism 200 is inserted into a tubular member is depicted in FIGS. 17-20. As illustrated in these figures, the insert body 202 of the latching mechanism 200 is inserted into the end of a tubular member 300 until the inner rim of its flanged first end 204 abuts the peripheral edge of the tubular member 300. When the insert body 202 of the latching mechanism 200 is fully inserted into the interior cavity of the tubular member 300, the detent 118 extends through the aperture 302 in the side wall of the tubular member 300 (see FIGS. 18 and 20).

Finally, referring primarily to the sectional view of FIG. 5 and the perspective views in FIGS. 24-27, the operation of the latching mechanisms 100, 200 will be described in detail. Initially, the manner in which the latching mechanisms 100, 200 are disengaged (i.e., released) will be explained. When an axial force Fₐₓ (i.e., a tensile force) is applied to the actuation cable 122, the bent elongated strip 120 is elastically deformed and the detent 118, 118′ attached thereto is displaced inwardly towards longitudinal axis LA (see FIG. 5) until it is completely removed from an aperture 307, 407 of an outer tubular member 303, 403 (the inner tubular member 300, 400 is telescopically received within an outer tubular member 303, 403). Once the detent 118, 118′ has been removed from the aperture 307, 407 in the outer tubular member 303, 403, the inner tubular member 300, 400 is capable of being slidably displaced with respect to the outer tubular member 303, 403. When the axial force Fₐₓ (i.e., the tensile force) is applied to the actuation cable 122, the first strip portion 120a of the bent elongated strip 120 together with detent 118, 118′ attached thereto is displaced inwardly towards longitudinal axis LA (during this inward displacement, the acute angle A between the first strip portion 120a and the fourth strip portion 120d is gradually decreased).

When it is desired to lock the position of the inner tubular member 300, 400 relative to the outer tubular member 303, 403 the respective apertures 302, 307 and 402, 407 in the inner and outer tubular members 300, 303 and 400, 403 are generally aligned with one another. Because the axial force Fₐₓ (i.e., the tensile force) is not being applied to the actuation cable 122, the detent 118, 118′ is gradually displaced outwardly (i.e., away from the longitudinal axis LA of FIG. 5) by the restoring force of the elastically deformed elongated strip 120 until it again lies within the aperture 307, 407 in the outer tubular member 303, 403. Once the detent 118, 118′ is disposed within the aperture 307, 407 of the outer tubular member 303, 403, the sliding movement of the inner tubular member 300, 400 relative to the outer tubular member 303, 403 is prevented. The restoring spring-like force of the elastically deformed elongated strip 120 results in the first strip portion 120a of the bent elongated strip 120 together with detent 118, 118′ attached thereto being displaced outwardly away from longitudinal axis LA (during this outward displacement, the acute angle A between the first strip portion 120a and the fourth strip portion 120d is gradually increased).

In the preferred embodiment of the invention, a cable actuation system is operatively coupled to a plurality of latching mechanisms 100, 200. Advantageously, the cable actuation system is configured to simultaneously disengage each of the latching mechanisms 100, or each of the latching mechanisms 200, so that the extended length of each inner tubular member 300, 400 remains generally consistent with regard to its respective outer tubular member. In other words, the cable actuation system is designed such that the inner tubular members 300, 400 move in a coordinated manner relative to their respective outer tubular members 303, 403.

It is readily apparent that the aforedescribed latching mechanisms 100, 200 offer numerous advantages. First, the latching mechanisms 100, 200 can be quickly and easily actuated from a remote location without the need to apply any manual forces to outer surfaces of the latching mechanisms themselves. Also, the latching mechanisms 100, 200 can be easily manufactured from readily available materials (e.g., polymeric and metallic materials). In addition, the latching mechanisms 100, 200 can be easily combined with other latching mechanisms 100, 200 in an assembly such that each of the latching mechanisms 100, 200 in the assembly is capable of being actuated in a simultaneous, or substantially simultaneous, manner when a user actuates a single release mechanism (e.g., by pulling on a handle or lever operatively coupled to multiple latching mechanisms 100, 200 via a system of cables or wires).

Although the invention has been shown and described with respect to a certain embodiment or embodiments, it is apparent that this invention can be embodied in many different forms and that many other modifications and variations are possible without departing from the spirit and scope of this invention.

While exemplary embodiments have been described herein, one of ordinary skill in the art will readily appreciate that the exemplary embodiments set forth above are merely illustrative in nature and should not be construed as to limit the claims in any manner. Rather, the scope of the invention is defined only by the appended claims and their equivalents, and not, by the preceding description.

The invention claimed is:

1. A cable-actuated latching mechanism comprising, in combination:
an insert body having at least one groove formed therein;
a bent elongated strip, a portion of said bent elongated strip disposed in said at least one groove of said insert body;
a detent coupled to said bent elongated strip; and
an actuation cable or wire operatively coupled to said bent elongated strip, a portion of said actuation cable or wire being disposed in said insert body;
wherein, when an axial force is applied to said actuation cable or wire, said bent elongated strip is elastically deformed and displaced inwardly, thereby displacing said detent in a similar inward manner.

2. The cable-actuated latching mechanism according to claim 1, wherein said insert body comprises a flanged end.

3. The cable-actuated latching mechanism according to claim 1, wherein said insert body comprises an aperture disposed transversely therethrough, one portion of said bent elongated strip configured to be received within said aperture.

4. The cable-actuated latching mechanism according to claim 3, wherein said at least one groove of said insert body comprises a first groove formed in a first surface of said insert body and a second groove formed in a second surface of said insert body, another portion of said bent elongated strip configured to be received within said first groove of said insert body, and a portion of said actuation cable or wire configured to be received within said second groove of said insert body.

5. The cable-actuated latching mechanism according to claim 4, wherein said insert body further comprises a dividing partition separating said first groove from said second groove.

6. The cable-actuated latching mechanism according to claim 4, wherein said first groove and said second groove of said insert body connect to said aperture that is disposed transversely through said insert body.

7. The cable-actuated latching mechanism according to claim 1, wherein said insert body has one of: (i) a substantially square cross-sectional shape, and (ii) a circular cross-sectional shape.

8. A cable-actuated latching mechanism comprising, in combination:
a bent elongated strip;
a detent coupled to said bent elongated strip; and
an actuation cable or wire operatively coupled to said bent elongated strip;
wherein, when an axial force is applied to said actuation cable or wire, said bent elongated strip is elastically deformed and displaced inwardly, thereby displacing said detent in a similar inward manner.

9. The cable-actuated latching mechanism according to claim 8, wherein said bent elongated strip comprises a first strip portion and a second strip portion, said second strip portion being bent at an acute angle relative to said first strip portion and having an aperture disposed therethrough for receiving said actuation cable or wire, said detent being attached to said first strip portion.

10. The cable-actuated latching mechanism according to claim 9, wherein said bent elongated strip further comprises a third strip portion and a fourth strip portion, said fourth strip portion being disposed at an acute angle relative to said first strip portion, said third strip portion comprising a filleted corner connecting said first strip portion to said fourth strip portion.

11. The cable-actuated latching mechanism according to claim 10, wherein said fourth strip portion of said bent elongated strip comprises a bent end, and wherein said bent end of said fourth strip portion is configured to act as a guide for said actuation cable or wire, said actuation cable or wire being configured to bend around said bent end of said fourth strip portion.

12. The cable-actuated latching mechanism according to claim 9, wherein said actuation cable or wire is provided with a flattened head portion so that said actuation cable or wire does not slip out of said aperture in said second strip portion.

13. The cable-actuated latching mechanism according to claim 8, wherein said detent has an eccentric conical shape so as to facilitate an insertion of said latching mechanism into an end of a tubular member.

14. A cable-actuated latching mechanism configured to selectively prevent the relative sliding movement of an inner tubular member relative to an outer tubular member, said cable-actuated latching mechanism comprising:
an insert body having at least one groove formed therein, said insert body configured to be received within an interior of said inner tubular member;
a bent elongated strip, a portion of said bent elongated strip disposed in said at least one groove of said insert body;
a detent coupled to said bent elongated strip; and
an actuation cable or wire operatively coupled to said bent elongated strip, a portion of said actuation cable or wire being disposed in said insert body;
wherein, when an axial force is applied to said actuation cable or wire, said bent elongated strip is elastically deformed and displaced inwardly, thereby displacing said detent in a similar inward manner and releasing said detent from an aperture in said outer tubular member so as to enable the relative sliding movement of said inner tubular member relative to said outer tubular member.

15. The cable-actuated latching mechanism according to claim 14, wherein said insert body further comprises an aperture disposed transversely therethrough, one portion of said bent elongated strip configured to be received within said aperture.

16. The cable-actuated latching mechanism according to claim 15, wherein said at least one groove of said insert body comprises a first groove formed in a first surface of said insert body and a second groove formed in a second surface of said insert body, another portion of said bent elongated strip configured to be received within said first groove of said insert body, and a portion of said actuation cable or wire configured to be received within said second groove of said insert body.

17. The cable-actuated latching mechanism according to claim 16, wherein said insert body further comprises a dividing partition separating said first groove from said second groove.

18. The cable-actuated latching mechanism according to claim 16, wherein said bent elongated strip comprises a first strip portion and a second strip portion, said second strip portion being bent at an acute angle relative to said first strip portion and having an aperture disposed therethrough for receiving said actuation cable or wire, said detent being attached to said first strip portion.

19. The cable-actuated latching mechanism according to claim 18, wherein said bent elongated strip further comprises a third strip portion and a fourth strip portion, said fourth strip portion being disposed at an acute angle relative to said first strip portion and having a bent end, said third strip portion comprising a filleted corner connecting said first strip portion to said fourth strip portion.

20. The cable-actuated latching mechanism according to claim 19, wherein a portion of said fourth strip portion of said bent elongated strip is received within said first groove of said insert body, and wherein said bent end of said fourth strip portion is received within said aperture that is disposed transversely through said insert body.
